(19) United States
(12) Patent Application Publication
(10) Pub. No.: US 2004/0108693 A1
(43) Pub. Date: Jun. 10, 2004

(54) Device for unrestricted side airbag or curtain deployment

(76) Inventors: Jason S. Foster, Waterford, MI (US); Michael W. Gorecki, Pontiac, MI (US); Richard E. Sajdak, Sterling Heights, MI (US)

Correspondence Address: DaimlerChrysler Intell. Capital Corp., 800 Chrysler Drive East, Auburn Hills, MI, 48326-2757, US

(21) Appl. No.: 10/310,806

(22) Filed: Dec. 6, 2002

(51) Int. Cl. B60R 21/22

(52) U.S. Cl. 280/730.2

(57) ABSTRACT

A device provides unrestricted deployment of an inflatable device in a vehicle. A bracket is configured to hold the inflatable device. The bracket is attached to the vehicle, with a portion of the bracket being configured to move toward an interior space of the vehicle such that a wall of the inflatable device is prevented from contacting interior objects in the vehicle adjacent the bracket.

### BACKGROUND OF THE INVENTION

The present invention relates to a side airbag curtain deployment device and, more particularly, to a mechanism that provides for unrestricted deployment of the side airbag curtain so as to prevent the rapidly inflating curtain from coming into contact with interior trim objects such as pillar trim and becoming damaged or not fully deployed.

Side-on collision protection in vehicles in the form of airbag modules and SABICs (side airbag inflatable curtain) provided at, for example, the B-pillar or from the A- to C-pillar is well known. Typical systems are described, for example, in U.S. Pat. Nos. 6,332,628; 6,443,485; and 6,464,251. Generally speaking, these devices have proved effective for protecting vehicle occupants in the event of side impacts whereby an airbag arranged behind a covering is caused by a gas generator to inflate over a lateral portion of the vehicle.

We have recognized, however, that with current SABIC designs as well as door-mounted side airbags, there is some possibility that, upon deployment of the curtain into the interior of the vehicle, the curtain may catch on certain interior trim objects such as a trim panel. This could of course, prevent the SABIC from fully performing its protective purpose if the curtain “hangs up” on the object and is damaged.

### SUMMARY OF THE INVENTION

An object of the present invention is to overcome the disadvantages encountered in conventional side-on protection devices through a simple structural mechanism that is low-cost and dependable.

This object has been achieved by the provision of a mechanism in the form of a pivotable ramp device that is part of an SABIC side airbag or cushion assembly and assures, upon deployment of the curtain or airbag, that any adjacent interior trim objects will be covered by the ramp device, thereby allowing smooth and full curtain deployment of the inflating device.

### BRIEF DESCRIPTION OF THE DRAWINGS

These and other objects, features and advantages of the present invention will become more readily apparent from the following detailed description of currently preferred configurations thereof when taken in conjunction with the accompanying drawings wherein:

FIG. 1 is a cross-sectional side view of the SABIC assembly without the SABIC itself being shown, in which a pivotable ramp is provided in accordance with the present invention;

FIG. 2 is a frontal view of the assembly as viewed in the direction of arrow D in FIG. 1;

FIG. 3 is a perspective view of the assembly shown in FIGS. 1 and 2 but with the stored SABIC shown; and

FIGS. 4A and 4B are cross-sectional side views of the assembly shown in FIG. 1 both before and upon deployment of the SABIC, in the latter figure showing movement of the pivotable ramp over an interior trim pillar.

### DETAILED DESCRIPTION OF THE DRAWINGS

Given the state of the art with regard to side airbag protection devices, unnecessary details concerning their construction, mounting at the vehicle and operation will be dispensed with for purposes of clarity. Such side inflatable curtain configurations and their method of incorporation and deployment in vehicles is shown, for example, in U.S. Pat. Nos. 6,231,071; 6,409,210; and 6,454,296, which are incorporated by reference herein.

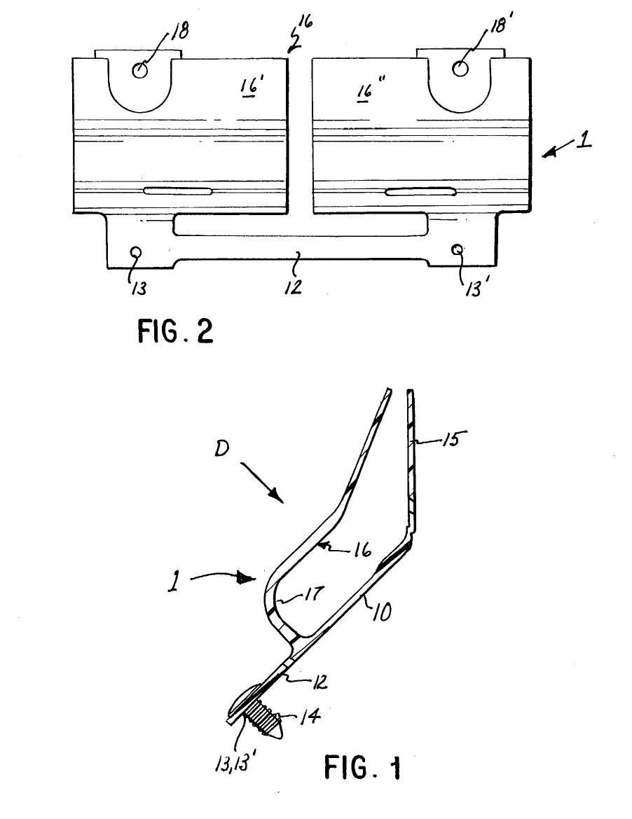

Referring now to FIGS. 1 and 2 of the drawings, the mechanism of the present invention essentially comprises a SABIC mounting bracket made of a suitable plastic or the like and designated generally by numeral 1. The outboard wall 10 of the bracket 1 as viewed in the direction of arrow D (FIG. 1) includes a lower portion 12 which has two lateral disposed areas with holes 13, 13′ through which fasteners 14 can be inserted for attaching the bracket 1 to the vehicle body inner or body in white (not shown) in a generally known manner. The upper portion 15 of the outboard wall 10 is arranged at an appropriate angle and/or is configured to be mountable by fasteners through holes 18, 18′ to a portion of the body inner or body in white or other appropriate location (not shown), again in a generally known manner.

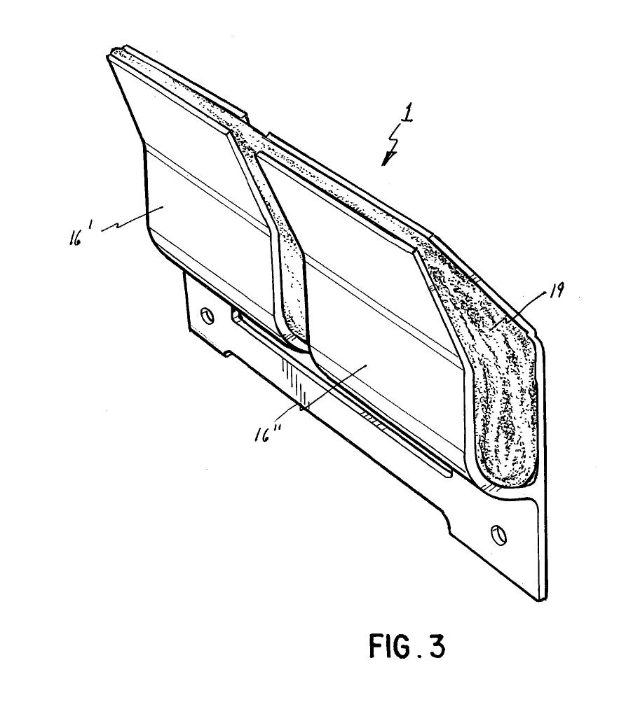

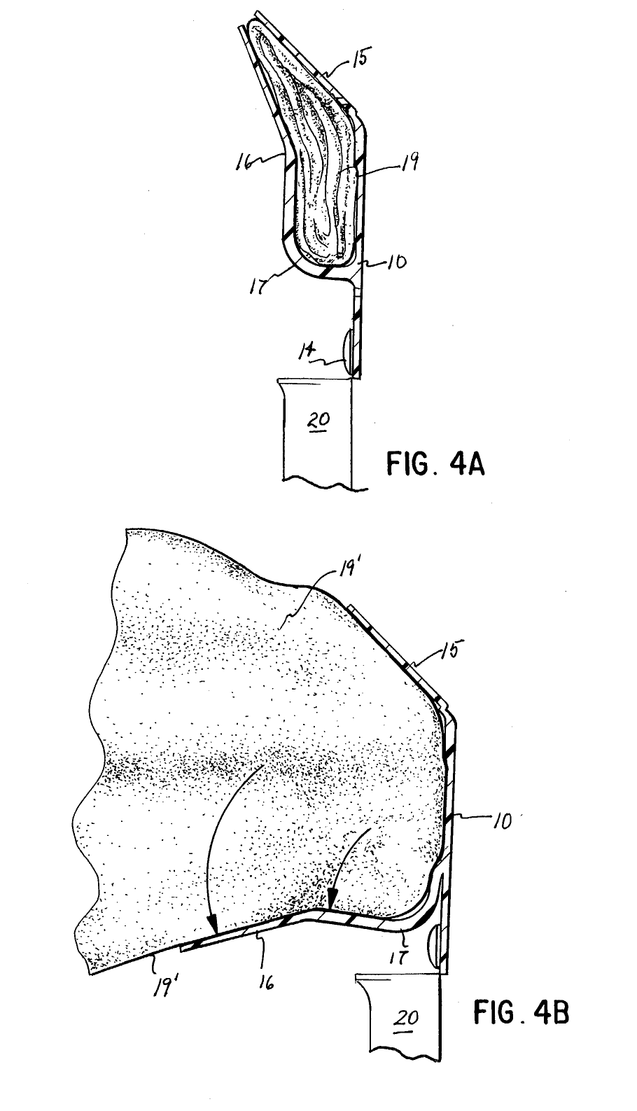

The inboard wall 16 of the bracket 1 can be divided into two (or more) separate sections 16′, 16″ joined by the lower portion 12 (FIG. 2) and is integrally connected with the outboard wall 10 by way of a transition area 17 of large curvature. The bracket 1 can be made from plastic using conventional molding or extrusion processes or of metal and other materials which do not form part of the present invention. The stored SABIC is designated by numeral 19 in FIGS. 3 and 4A. In the latter, a trim pillar 20 is located below the SABIC assembly 1 and, unless otherwise prevented, in the path of the SABIC 19. As seen in FIG. 4B, however, upon firing an inflator device and delivery gas to the SABIC 19 as seen in FIG. 4B, the inboard wall 16 is forced to pivot around the large curvature transition zone 17 such that the inboard wall 16 prevents the curtain wall 19′ from coming into contact with the trim pillar 20 and instead resting against the small interior face of the inboard wall 16.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

We claim:

1. A device for providing unrestricted deployment of an inflatable device in a vehicle, comprising a bracket configured to hold the inflatable device, and means for attaching the bracket to the vehicle, wherein a portion of the bracket is configured to move toward an interior space of the vehicle such that a wall of the inflatable device is prevented from contacting interior objects in the vehicle adjacent the bracket.

2. A device according to claim 1, wherein the inflatable device is a side airbag inflatable curtain.

3. A device according to claim 1, wherein the portion is a wall having a region configured to permit movement of the wall.

4. A device according to claim 3, wherein the region is configured as a curved wall sufficient to allow pivoting movement of the portion of the bracket.

5. Mechanism for permitting deployment of an inflatable device for protecting occupants of a vehicle, comprising means for holding the inflatable device and allowing the inflatable device to deploy without encountering interior trim objects on the vehicle, and means for securing the holding means at a predetermined position inside the vehicle to protect the occupants in the event of collision or rollover.

6. A side-impact device for protecting occupants of a vehicle, comprising
an inflatable device consisting of a cushion, curtain or airbag;
an outboard wall attachable to the vehicle; and
an inboard wall arranged to face toward an interior of the vehicle and being formed in at least one section and integrally joined to the outboard wall so as to be movable;
wherein the inflatable device is arranged between inside surfaces of the inboard wall and the outboard wall so that, upon deployment of the inflatable device, the inboard wall is caused to move away from the outboard wall without separating from the outboard wall and preventing the inflatable device from contacting interior portions of the vehicle adjacent an outer surface of the inboard wall.
